(19) United States
(12) Patent Application Publication
(10) Pub. No.: US 2007/0082618 A1
(43) Pub. Date: Apr. 12, 2007

(54) Multipurpose vehicle internal rearview mirror

(75) Inventors: Kuo-Rong Chen, Panchiao City (TW); Chun-Chung Lee, Taipei (TW); Cheng-Hung Huang, Miaoli Hsien (TW)

Correspondence Address: BACON & THOMAS, PLLC, 625 SLATERS LANE, FOURTH FLOOR, ALEXANDRIA, VA, 22314, US

(73) Assignee: Sin Etke Technology Co., Ltd., Taipei City (TW)

(21) Appl. No.: 11/453,816

(22) Filed: Jun. 16, 2006

(30) Foreign Application Priority Data
Oct. 7, 2005 (TW) 094217434

(51) Int. Cl. H04B 7/00; H04B 1/00

(52) U.S. Cl. 455/66.1; 381/86

(57) ABSTRACT

A vehicle internal rearview mirror is disclosed to include a casing with a semi-transparent mirror, indicator units mounted in the casing, a data storage device stored with digital format music files, a music player, which is mounted inside the casing, having a digital music file decoder that fetches and decodes digital format music files from the data storage device, and a FM transmitter, which is controlled by the digital music file decoder to send out the decoded digital format music files to the FM radio of the car for output through the car speakers, and a Bluetooth device for controlling the music player to play music and the indicator units to display different information.

### BACKGROUND OF THE INVENTION

1. Field of the Invention

The present invention relates to a vehicle internal rearview mirror and more particularly, to a multipurpose vehicle internal rearview mirror that can display living information about food entertainment, shopping, and housing, and can control the playing of music.

2. Description of Related Art

There are known vehicle internal rearview mirrors that can be controlled to display ambient temperature, back distance, telephone number, and etc., so that the driver can conveniently obtain related traveling information or living information while driving the car.

Further, following fast development of technology, digital music files (for example, MP3) have become popular. However, when wishing to play a digital music file, for example, MP3 format music file in a motor vehicle, it is necessary to install a MP3 music player or converter means in the motor vehicle at first.

However, installing a MP3 music player or converter means in a motor vehicle affects the arrangement and looking of vehicle internal space. Further, it is inconvenient and dangerous to the motor vehicle driver to operate many different devices while driving the motor vehicle.

### SUMMARY OF THE INVENTION

The present invention has been accomplished under the circumstances in view. According to the present invention, the vehicle internal rearview mirror comprises a casing, a plurality of indicator units, a data storage device, a music player, and a wireless Bluetooth unit. The casing has a semi-transparent mirror covered on the front side thereof. Further, the casing defines therein a holding space and a compartment in the holding space. The indicator units are mounted inside the holding space and facing the back side of the semi-transparent mirror.

Further, the data storage device has stored therein at least one digital format music file. The music player is mounted in the compartment inside the casing, comprising a digital music file decoder and a FM (Frequency Modulation) transmitter. The digital music file decoder is respectively electrically connected to the data storage device and the FM transmitter. The digital music file decoder is adapted to fetch the at least one digital format music file from the data storage device, and to decode the fetched digital format music file, the FM transmitter is adapted to wirelessly send out the decoded digital format music file.

Further, the wireless Bluetooth unit is mounted in the holding space inside the casing and electrically connected to the indicator units and the music player. The wireless Bluetooth unit is adapted to receive an external wireless Bluetooth signal for controlling the music player to play music and for controlling the indicator units to display data.

Therefore, by means of wireless Bluetooth transmission, the invention can control the music player of the vehicle internal rearview mirror to drive the FM transmitter to send out music signal to the FM radio of the car for output through the car speakers. By means of wireless Bluetooth transmission, the invention can also control the indicator units of the vehicle internal rearview mirror to display English words, numerals, telephone numbers, and other customs service information about food, entertainment, shopping and housing. The present invention effectively saves much the internal space of the car and reduces vehicle internal wiring, thereby making the inside of the car neat and beautiful.

The music player further comprises a USB (Universal Serial Bus) socket. The data storage device further comprises a USB (Universal Serial Bus) plug connectable to the USB socket of the music player. By means of the USB plug, the data storage device is connectable to a computer to extend MP3 format music files.

Further, the indicator units include a 7-segment display for displaying English words, numerals, telephone numbers, or other information.

Further, the at least one digital format music file includes at least one MP3 format music file. Of course, the each digital format music file can be a WAM format or MIDI format music file.

The music player further comprises a memory. By means of the memory, digital format music files can be stored in the music player or the music player can directly play digital format music files.

Further, the invention can be used with an on-vehicle control module. The on-vehicle control module comprises a wireless Bluetooth device adapted to send out the external wireless Bluetooth signal.

The on-vehicle control module further comprises a global positioning unit and an electronic map database. The on-vehicle control module fetches the current coordinates data calculated by the global positioning unit, and compares the current coordinates data to the storage data of the electronic map database so as to select customs service information related to the current coordinates data and then to send out the selected customs service information through the wireless Bluetooth device.

Further, the customs service information is selected from at least one of the information group of food information, clothing information, housing information, transportation information, education information, and entertainment information.

Further, the on-vehicle control module further comprises a mobile telephone. The on-vehicle control module further controls the wireless Bluetooth device to send out a communication message (for example, caller ID, dial message, and etc.) produced by the mobile telephone when communicating. By means of the mobile telephone, the on-vehicle control module is connectable to an external device to extend, download, or update electronic map data and to store the data in the electronic map database.

The vehicle internal rearview mirror further comprises a plurality of control buttons mounted on the outside of the casing and electrically connected to the indicator units and the music player. The control buttons are used to control the brightness of the indicator units, the music playing operation of the music player, and other functions.

The control buttons include an emergency call button electrically connected to the wireless Bluetooth unit. Therefore, the emergency call button can send a SOS signal to the outside through the mobile telephone via the wireless Bluetooth unit and the wireless Bluetooth device.

### BRIEF DESCRIPTION OF THE DRAWINGS

FIG. 1 is a schematic system block diagram of the present invention.

FIG. 2 is an exploded view of the vehicle internal rearview mirror according to the present invention.

FIG. 3 is a functional block diagram of the music player and data storage device of the vehicle internal rearview mirror according to the present invention.

FIG. 4 is a functional block diagram of an on-vehicle control module according to the present invention.

### DETAILED DESCRIPTION OF THE PREFERRED EMBODIMENT

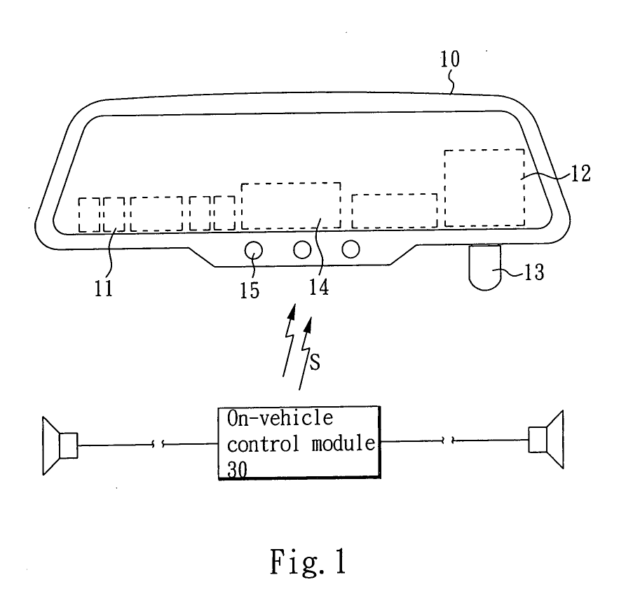

Referring to FIG. 1, a vehicle internal rearview mirror in accordance with the present invention is shown comprising a casing 10, a plurality of indicator units 11, a data storage device 12, a music player 13, a wireless Bluetooth unit 14, and control buttons 15.

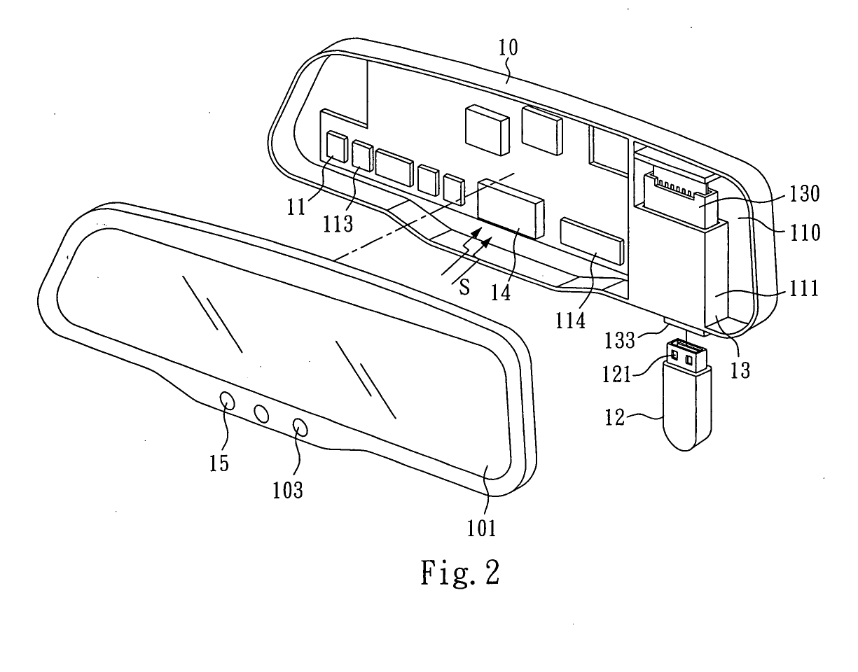

Referring to FIG. 2, the casing 10 is covered with a semi-transparent mirror 101 for display of electronic data directly, defining a holding space 110 and a compartment 111 in the holding space 110.

According to this embodiment, the indicator units 11 are installed in the holding space 110 inside the casing 10 and facing the back side of the semi-transparent mirror 101. The indicator units 11 include one 7-segment display 114 and a plurality of icon displays 113. The 7-segment display 114 is adapted to display English words, numerals, and telephone numbers. The icon displays 113 are adapted to display customs service information about food, entertainment, shopping, and housing.

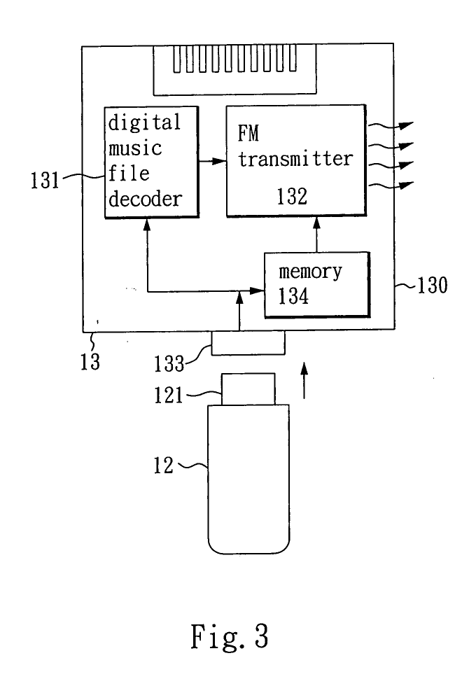

FIG. 3 is a functional block diagram of the music player 13 and the data storage device 12. The data storage device 12 has stored therein at least one digital format music file, for example, MP3 format, WMA format, or MIDI format music file. According to this embodiment, the at least one digital format music file each is a MP3 format music file. The data storage device 12 has a USB plug 121 connectable to a USB socket of a computer to extend MP3 format music files.

Referring to FIGS. 2 and 3 again, the music player 13 is installed in the compartment 111 inside the casing 10, comprising a retractable case 130, a digital music file decoder 131, a FM (Frequency Modulation) transmitter 132, a USB socket 133, and a memory 134. The retractable case 130 is inserted into compartment 111 inside the casing 10. The digital music file decoder 131 is respectively electrically connected to the data storage device 12 and the FM transmitter 132. Further, the digital music file decoder 131 fetches and decodes the MP3 format music file that is stored in the data storage device 12, and sends out the decoded music data through the FM transmitter 132 for receiving by the FM radio of the car and further output through the car speakers. A MP3 format music file may be stored in the built-in memory 134 for direct output. The USB socket 133 is adapted to receive the USB plug 121 of the data storage device 12.

In FIG. 2, the wireless Bluetooth unit 14 is mounted in the holding space 110 inside the casing 10 and electrically connected to the indicator units 11 and the music player 13. The wireless Bluetooth unit 14 is adapted to receive an external wireless Bluetooth signal S that controls the music playing operation of the music player 13 and data display operation of the indicator units 11.

According to this embodiment, the control buttons 15 are mounted on the outside of the casing 10 and electrically connected to the indicator units 11 and the music player 13 for controlling the brightness of the indicator units 11, the music playing operation of the music player 13, and other control functions. The control buttons 15 include on emergency call button 103, which is electrically connected to the wireless Bluetooth unit 14 for driving the wireless Bluetooth unit 14 to send out a wireless SOS signal.

Therefore, the invention can control the music player 13 in the vehicle internal rearview mirror 1, by means of wireless Bluetooth transmission, to drive the FM transmitter to send out music signal to the FM radio of the car for output through the car speakers. By means of wireless Bluetooth transmission, the invention can also control the indicator units 11 of the vehicle internal rearview mirror 1 to display English words, numerals, telephone numbers, and other customs service information about food, entertainment, shopping and housing. The present invention effectively saves much the internal space of the car and reduces vehicle internal wiring, thereby making the inside of the car neat and beautiful.

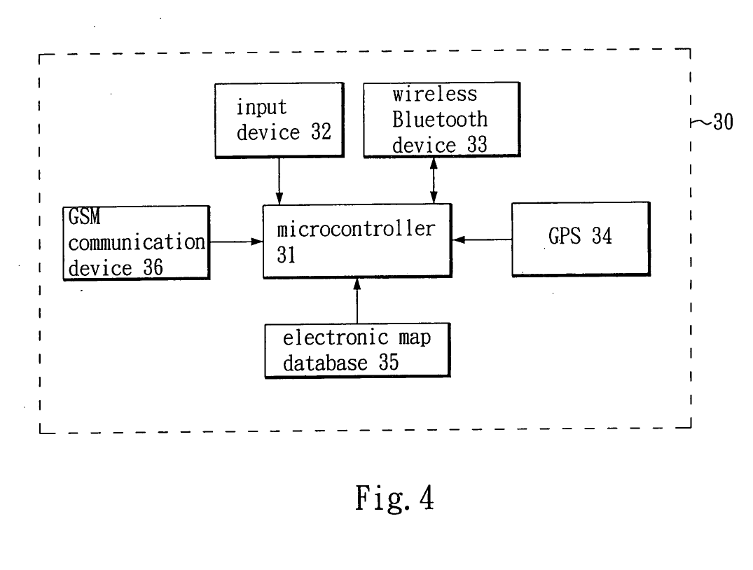

Further, the invention can be used with an on-vehicle control module 30. FIG. 4 is a functional block diagram of this on-vehicle control module 30. Referring to FIGS. 1˜4, the on-vehicle control module 30 comprises a microcontroller 31, an input device 32, a wireless Bluetooth device 33, a global positioning device 34, an electronic map database 35, and a mobile telephone 36.

The microcontroller 31 is the control center of the on-vehicle control muddle 30. The input device 32 is for data input. The wireless Bluetooth device 33 is adapted to outputs a wireless Bluetooth signal S. The global positioning device 34 is adapted to calculate the global coordinates of the current location of the car. The electronic map database 35 has stored therein multiple electronic map data. The on-vehicle control module 30 fetches the global coordinates of the current location of the car calculated by the global positioning device 34, and the compares the data to the storage data of the electronic map database 35 so as to select the related customs service information and then to send out the selected customs service information through the wireless Bluetooth device 33 wirelessly. The customs service information is selected from one of the groups of food, clothing, housing, transportation, education, and entertainment, for example, the living information about food, entertainment, shopping and housing.

Further, the mobile telephone 36 of the on-vehicle control module 30 according to this embodiment is a GSM communication device. The on-vehicle control module 30 sends the communication message of the mobile telephone 36, for example, the caller ID, dial message, or the like to the vehicle internal rearview mirror 1 through the wireless Bluetooth device 33 for display. Further, the mobile telephone 36 is connectable to the outside to extend, update, or download electronic map data.

Although the present invention has been explained in relation to its preferred embodiment, it is to be understood that many other possible modifications and variations can be made without departing from the spirit and scope of the invention as hereinafter claimed.

What is claimed is:

1. A vehicle internal rearview mirror comprising:
a casing, said casing having a semi-transparent mirror covered on a front side thereof and defining therein a holding space, and a compartment in said holding space;
a plurality of indicator units mounted inside said holding space and facing a back side of said semi-transparent mirror;
a data storage device, said data storage device having stored therein at least one digital format music file;
a music player mounted in said compartment inside said casing, said music player comprising a digital music file decoder and a FM (Frequency Modulation) transmitter, said digital music file decoder being respectively electrically connected to said data storage device and said FM transmitter, said digital music file decoder being adapted to fetch said at least one digital format music file from said data storage device, and to decode the fetched digital format music file, said FM transmitter being adapted to wirelessly send out the decoded digital format music file; and
a wireless Bluetooth unit mounted in the holding space inside said casing and electrically connected to said indicator units and said music player, said wireless Bluetooth unit being adapted to receive an external wireless Bluetooth signal for controlling said music player to play music and for controlling said indicator units to display data.

2. The vehicle internal rearview mirror as claimed in claim 1, wherein said music player comprises a retractable case detachably inserted into said compartment inside said casing.

3. The vehicle internal rearview mirror as claimed in claim 1, wherein said music player further comprises a USB (Universal Serial Bus) socket; said data storage device further comprises a USB (Universal Serial Bus) plug connectable to the USB socket of said music player.

4. The vehicle internal rearview mirror as claimed in claim 1, wherein said indicator units include a 7-segment display.

5. The vehicle internal rearview mirror as claimed in claim 1, wherein said indicator units include a plurality of icon displays.

6. The vehicle internal rearview mirror as claimed in claim 1, wherein said at least one digital format music file includes at least one MP3 format music file.

7. The vehicle internal rearview mirror as claimed in claim 1, wherein said music player further comprises a memory therein.

8. The vehicle internal rearview mirror as claimed in claim 1, which is used with an on-vehicle control module, said on-vehicle control module comprising a wireless Bluetooth device adapted to send out said external wireless Bluetooth signal.

9. The vehicle internal rearview mirror as claimed in claim 8, wherein said on-vehicle control module further comprises a global positioning unit and an electronic map database, said on-vehicle control module fetches the current coordinates data calculated by said global positioning unit, and compares the current coordinates data to the storage data of said electronic map database so as to select customs service information related to the current coordinates data and then to send out the selected customs service information through said wireless Bluetooth device.

10. The vehicle internal rearview mirror as claimed in claim 9, wherein said customs service information is selected from at least one of the information group of food information, clothing information, housing information, transportation information, education information, and entertainment information.

11. The vehicle internal rearview mirror as claimed in claim 8, wherein said on-vehicle control module further comprises a mobile telephone, said on-vehicle control module further controls said wireless Bluetooth device to send out a communication message produced by said mobile telephone when communicating.

12. The vehicle internal rearview mirror as claimed in claim 1, further comprising a plurality of control buttons mounted on the outside of said casing and electrically connected to said indicator units and said music player.

13. The vehicle internal rearview mirror as claimed in claim 12, wherein said control buttons include an emergency call button electrically connected to said wireless Bluetooth unit.
